(19) United States
(12) Patent Application Publication
(10) Pub. No.: US 2025/0191604 A1
(43) Pub. Date: Jun. 12, 2025

(54) SOURCE SEPARATION COMBINING SPATIAL AND SOURCE CUES

(71) Applicant: Dolby Laboratories Licensing Corporation, San Francisco, CA (US)

(72) Inventors: Aaron Steven MASTER, San Francisco, CA (US); Lie LU, Dublin, CA (US)

(73) Assignee: Dolby Laboratories Licensing Corporation, San Francisco, CA (US)

(21) Appl. No.: 18/852,341

(22) PCT Filed: Mar. 17, 2023
(86) PCT No.: PCT/US2023/015507

§ 371 Date: Sep. 27, 2024

Related U.S. Application Data
(60) Provisional application No. 63/325,108, filed on Mar. 29, 2022.
(60) Provisional application No. 63/417,273, filed on Oct. 18, 2022.
(60) Provisional application No. 63/482,949, filed on Feb. 2, 2023.

(51) Int. Cl. G10L 21/0272; G10L 21/0232; G10L 25/30

(52) U.S. Cl. CPC G10L 21/0272; G10L 21/0232; G10L 25/30

(57) ABSTRACT

The present disclosure relates to a method and system for processing audio for source separation. The method comprises obtaining an input audio signal (A) comprising at least two channels and processing the input audio signal (A) with a spatial cue based separation module (10) to obtain an intermediate audio signal (B). The spatial cue based separation module (10) is configured to determine a mixing parameter of the at least two channels of the input audio signal (A) and modify the channels, based on the mixing parameter, to obtain the intermediate audio signal (B). The method further comprises processing the intermediate audio signal (B) with a source cue based separation module (20) to generate an output audio signal (C), wherein the source cue based separation module (20) is configured to implement a neural network trained to predict a noise reduced output audio signal (C) given the intermediate audio signal (B).

### CROSS-REFERENCE TO RELATED APPLICATIONS

This application claims priority to U.S. provisional application 63/325,108, filed Mar. 29, 2022, U.S. provisional application 63/417,273, filed Oct. 18, 2022, and U.S. provisional application 63/482,949, filed Feb. 2, 2023, each application of which is incorporated herein by reference in its entirety.

### TECHNICAL FIELD OF THE INVENTION

The present invention relates to a method and audio processing system for performing source separation based on spatial and source cues.

### BACKGROUND OF THE INVENTION

Source separation in audio processing relates to systems and methods for isolating a target audio source (e.g. speech or music) present in an original audio signal comprising a mix of the target audio source and additional audio content. The additional audio content is for example stationary or non-stationary noise, background audio or reverberation effects.

There are mainly two types of target separation processing, namely spatial cue based separation which utilizes spatial cues (information describing how the target audio is mixed) and source cue based separation which utilizes source cues (information describing what the target audio sounds like).

A simple example of spatial cue separation is the case of extracting speech from a 5.1 soundtrack of a movie. The spatial cue for such separation is that speech or dialogue is commonly mixed to the center (C) channel, whereby a spatial separation system simply extracts the center channel to obtain a spatially separated dialogue channel. Alternatively, the spatial cue based separation involves amplifying the center channel or mixing the center channel to the remaining channels in the 5.1 presentation to obtain a 5.1 presentation with enhanced dialogue intelligibility.

A simple example of source cue based separation is the case of utilizing a band-pass filter with a pass-band adapted to match the expected frequency range of the target audio source. If the target audio source is speech, a band-pass filter with a pass-band of 500 Hz to 8 kHz can be used since the spectral energy of most human speech is expected to exist within this frequency range. More advanced source cue separation systems operate on audio signals represented in a time-frequency domain and employ a neural network trained to predict gains for each time-frequency tile of the audio signal, wherein the gains suppress all audio content which does not belong to the target audio source.

### GENERAL DISCLOSURE OF THE INVENTION

A problem with the above mentioned solutions is that a source cue based separation process utilizing source cues completely ignores the spatial cues and vice versa, meaning that all information is not considered when performing target source separation. On the other hand, combining different source separation processes is not trivial and in many cases combining two or more different target source separation processes results in inferior performance compared to using only one target source separation process.

To this end, there is a need for an improved target separation method and system which overcomes at least some of the drawbacks mentioned in the above.

According to a first aspect of the invention there is provided a method of processing audio for source separation. The method comprises obtaining an input audio signal comprising at least two channels and processing the input audio signal with a spatial cue based separation module to obtain an intermediate audio signal. The spatial cue based separation module is configured to determine a mixing parameter of the at least two channels of the input audio signal and modify the at least two channels, based on the mixing parameter, to obtain the intermediate audio signal. The method further comprises processing the intermediate audio signal with the source cue based separation module to generate an output audio signal, wherein the source cue based separation module is configured to implement a neural network trained to predict a noise reduced output audio signal given samples of the intermediate audio signal.

The noise which the source cue based separation module is configured to remove is at least one of stationary noise (such as white noise), non-stationary noise (comprising time-varying noise such as traffic noise or wind noise), background audio content (e.g. speech from sources other than a target speaker) and reverberation.

In other words, while the spatial cue based separation module is configured to separate audio content based on how it is mixed and the source cue based separation module is configured to separate audio content based on how it sounds.

By performing the spatial cue based source separation using the mixing parameter first and then subsequently performing the neural network based source cue based separation the overall performance of the source separation method is improved. Especially, since the neural network based source cue based separation may be trained specifically for operating on spatially separated audio sources, and the preceding spatial cue based separation module achieves such spatial separation, the performance of the source cue based separation module is enhanced. In one example, the spatial cue based separation module modifies the input audio signal to approach a center panned mixing, which is approximately monaural, and the source cue based separation module is trained to suppress the noise for centered panned audio signals.

In some implementations, the spatial cue based separation module operates at a first time and/or frequency resolution, and the method further comprises providing, by the spatial cue based separation module, metadata to the source cue based separation module, wherein the metadata indicates the time and/or frequency resolution of the spatial cue based separation module. The method further comprises generating, by the source cue based separation module, the output audio signal based on the intermediate audio signal and the metadata.

For example, the time and/or frequency resolution of the source cue based separation module is reduced to match the time and/or frequency of the spatial cue based separation module. In some examples, the time and/or frequency resolution of the source cue based separation module is reduced by processing the output of the source cue based separation module with a smoothing window and/or a smoothing kernel. If the time and/or frequency metadata is not considered the two separation modules will operate independently at different resolutions which may lead to perceptible acoustic artifacts.

In some implementations, the source cue based separation module predicts a source gain mask which is applied to the intermediate audio signal to suppress the noise. The time and/or frequency resolution metadata may be used to smooth the gain mask to form a smoothed gain mask which is applied to the intermediate audio signal. Wherein the level of smoothing (i.e. decrease in resolution) is based on the time and/or frequency metadata.

In some implementations, the spatial cue based separation module determines the mixing parameter with a time and/or frequency resolution which is lower (coarser) than the time and/or frequency resolution of the source cue based separation module, preferably at least two times lower, more preferably at least four times lower, even more preferably at least six times lower or most preferably at least eight times lower.

That is, there may be a large difference in the time and/or frequency resolution of the two modules since the time and/or frequency resolution most suitable for spatial cue based separation differs substantially from the corresponding time and/or frequency resolution for performing source cue based separation.

According to a second aspect of the invention there is provided a system for source separation comprising a spatial cue based separation module, configured to obtain an input audio signal comprising at least two channels and process the input audio signal to obtain an intermediate audio signal, wherein the spatial cue based separation module is configured to determine a mixing parameter of the at least two channels of the input audio signal and modify the at least two channels, based on the mixing parameter, to obtain the intermediate audio signal. The system further comprising a source cue based separation module configured to process the intermediate audio signal to generate an output audio signal by implementing a neural network trained to predict a noise reduced output audio signal given samples of the intermediate audio signal.

The system of the second aspect features the same or equivalent benefits as the method according to the first aspect. Any functions described in relation to a method may have corresponding features in a system or device, and vice versa.

### BRIEF DESCRIPTION OF THE DRAWINGS

Aspects of the present invention will be described in more detail with reference to the appended drawings, showing currently preferred embodiments.

FIG. 1 is a block diagram of an audio processing system for source separation according to some implementations.

FIG. 2 is a block diagram illustrating an audio processing system for source separation with remixing of the input audio signal according to some implementations.

FIG. 3 is a flowchart describing a method for processing audio for source separation according to some implementations.

FIG. 4 is a block diagram showing an audio processing system for source separation with a source cue based separation module which predicts a source separation gain mask according to some implementations.

FIG. 5 is a block diagram illustrating an audio processing system for source separation cooperating with a classifier unit and gating unit according to some implementations.

### DETAILED DESCRIPTION OF CURRENTLY PREFERRED EMBODIMENTS

Systems and methods disclosed in the present application may be implemented as software, firmware, hardware or a combination thereof. In a hardware implementation, the division of tasks does not necessarily correspond to the division into physical units; to the contrary, one physical component may have multiple functionalities, and one task may be carried out by several physical components in cooperation. The computer hardware may for example be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions (sequential or otherwise) that specify actions to be taken by that computer hardware. Further, the present disclosure shall relate to any collection of computer hardware that individually or jointly execute instructions to perform any one or more of the concepts discussed herein.

Certain or all components may be implemented by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system (i.e. a computer hardware) that includes one or more processors. Each processor may include one or more of a CPU, a graphics processing unit, and a programmable DSP unit. The processing system further may include a memory subsystem including a hard drive, SSD, RAM and/or ROM. A bus subsystem may be included for communicating between the components. The software may reside in the memory subsystem and/or within the processor during execution thereof by the computer system.

The one or more processors may operate as a standalone device or may be connected, e.g., networked to other processor(s). Such a network may be built on various different network protocols, and may be the Internet, a Wide Area Network (WAN), a Local Area Network (LAN), or any combination thereof.

The software may be distributed on computer readable media, which may comprise computer storage media (or non-transitory media) and communication media (or transitory media). As is well known to a person skilled in the art, the term computer storage media includes both volatile and non-volatile, removable and non-removable media implemented in any method or technology for storage of information such as computer readable instructions, data structures, program modules or other data. Computer storage media includes, but is not limited to, physical (non-transitory) storage media in various forms, such as EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by a computer. Further, it is well known to the skilled person that communication media (transitory) typically embodies computer readable instructions, data structures, program modules or other data in a modulated data signal such as a carrier wave or other transport mechanism and includes any information delivery media.

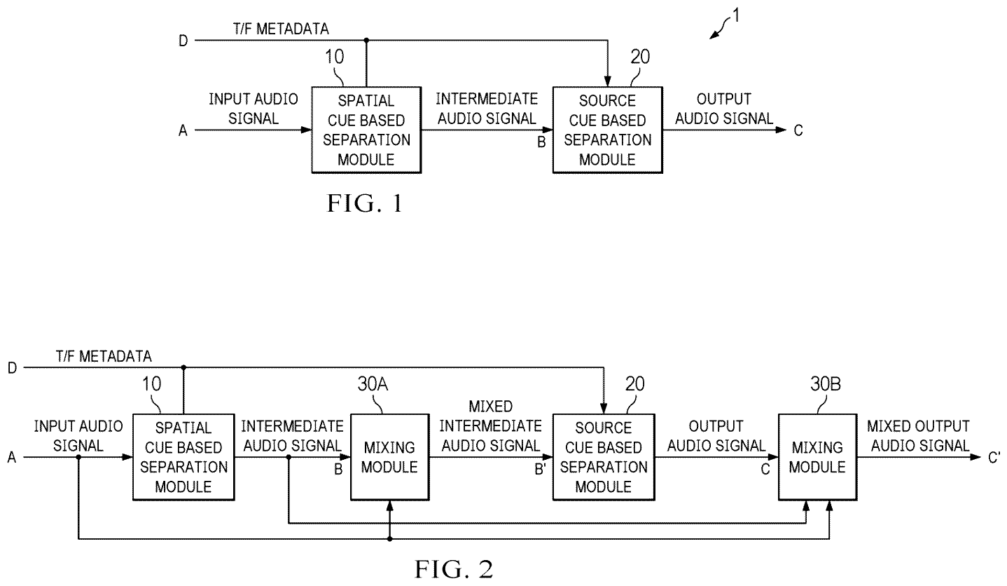

FIG. 1 depicts a source separation audio processing system 1 for performing source separation based on both spatial cues and source cues. The audio processing system 1 obtains an input audio signal A which is provided to the spatial cue based separation module 10. The spatial cue based separation module 10 processes the input audio signal A and outputs an intermediate audio signal B.

The input audio signal A comprises at least two audio channels. For example, the input audio signal A is a stereo or binaural audio signal with a left and a right audio channel. The spatial cue based separation module 10 is configured to extract at least one mixing parameter of the input audio signal A and modify the at least two audio channels based on the at least one mixing parameter to obtain the intermediate audio signal B.

The mixing parameter indicates a property of the mixing of the at least two audio channels. One or more mixing parameters may be determined for a single frequency band or for multiple frequency bands and updated regularly. For example, the audio signal is divided into a plurality of consecutive (optionally overlapping) chunks and the mixing parameter is determined by aggregating a fine granularity mixing parameter across at least one chunk frequency band. In some implementations, the mixing parameter indicates at least one of a distribution of the panning of the at least two channels and a distribution (e.g. the mean or median) of the inter-channel phase difference of the at least two audio channels in a chunk frequency band. A chunk comprises at least two frames, wherein each frame in turn is divided in to a plurality of tiles covering a narrow frequency bands as will be described further in the below.

The processing performed by the spatial cue based separation module 10 may entail adjusting the at least two audio channels, based on the detected mixing parameter, to approach a predetermined mixing type. In some implementations, at least two different mixing parameters (e.g. both a distribution of the panning and a distribution of the inter-channel phase difference) are determined and used when adjusting the mixing. One example of this is presented below, where four mixing parameters Θ-middle, Θ-width, Φ-middle, Φ-width are determined and used to adjust the mixing. The predetermined mixing type is selected based on the capabilities of the subsequent source cue based separation module 20. For example, the predetermined mixing type may be an approximately center-panned mixing and/or a mixing with little to none inter-channel phase difference.

For example, the subsequent source cue based separation module 20 may be configured to process a downmixed version of the intermediate audio signal B with at least two channels. In some implementations, the source cue based separation module 20 first extracts a downmixed mid audio signal from the at least two channels of the intermediate audio signal B, analyses the downmixed mid audio signal to determine masking gains to suppress the noise in the downmixed mid signal and applies the masking gains to the intermediate audio signal B channels. To this end, the already spatially separated intermediate audio signal B is center-panned and/or contains little to none inter-channel phase difference and will be well suited for processing with this type of source cue based separation module 20 as e.g. most of the desired content will be included in the downmix mid signal. By comparison, if the intermediate audio signal B would not be spatially separated there is a risk that relevant audio content will be excluded from the downmix, and not considered properly by the neural network of the source cue based separation module 20.

The spatial cue based separation module 10 can operate in a transform domain, such as in Short-Time Fourier Transform (STFT) domain or quadrature mirror filterbank (QMF) domain, or in a time domain, such as in waveform domain. In either case, the input audio signal A comprises at least two audio channels, such as a left L and a right R channel of a stereo audio signal. However, the audio channels are not necessarily a left and right channel L, R and may e.g. be a left L and center channel C of a 5.1 presentation, a center C and right R channel of a 5.1 presentation, or any selection of two audio channels of an arbitrary presentation. Furthermore, by “the input audio signal comprises at least two audio channels” input is here intended any audio input with multiple signals, not only such signals conventionally referred to as “channels”. For example, the signals of the input audio signal may include surround audio channels, multi-track signals, higher order ambisonic signals, object audio signals and/or immersive audio signals. The input audio signal A may be divided into a plurality of consecutive time domain frames wherein each frame is further divided into a plurality of tiles, each tile covering a narrow frequency band, giving a fine granularity tile representation. The tiles are sometimes referred to as time-frequency tiles and as an example each tile covers an individual STFT-frequency bin. Accordingly, each tile represents a limited time duration of the audio signal in a predetermined narrow frequency band. Each fine-granularity time-frequency tile represents a very short time duration and/or narrow frequency band (for example about one or more orders of magnitude shorter and/or narrower) compared to a chunk, which comprises all tiles of at least two consecutive frames.

The frequency band covered by one tile is usually quite narrow, e.g. around 10 Hz and the time duration covered by each tile or frame is also quite short, e.g. around 20 ms. A chunk (comprising at least two consecutive frames) covers a longer time duration (e.g. 10 consecutive frames) and it also envisaged that the chunk can be divided into chunk frequency bands, wherein the chunk frequency bands are wider compared to the frequency bands covered by individual tiles. For instance, a chunk may be realized with chunk frequency bands of e.g. 400 to 800 Hz, 800 to 1600 Hz, 1600 Hz to 3200 Hz and so on which is much wider compared to the more narrow frequency band covered by each tile.

In a first example of the operation of the spatial cue based separation module 10 this module first detects fine granularity mixing parameters for each tile (e.g. STFT-tile) of the input audio signal A. Secondly, the spatial cue based separation module 10 determines a distribution(s) of the fine granularity mixing parameters across multiple tiles and modifies the channels based on the distribution(s) of the fine granularity mixing parameters. When describing this and other examples it will be assumed that the audio channels are left and right channels L, R however the same processing may be applied for any pair audio channels as mentioned in the above, e.g. an LC (left and center) pair, RC (right and center) pair or a Ls-Rs (left-surround and right-surround) pair.

For each fine granularity tile, a detected panning mixing parameter Q of the left and right L, R audio channels can be determined as

$$Θ = arc tan ( \frac{R}{L} ) \qquad ( eq . 1 )$$

wherein Θ ranges from 0 (indicating a fully left L panned audio signal) to π/2 (indicating a fully right R panned audio signal) with Θ=π/4 indicating a center panned audio signal.

Similarly, for each fine granularity tile a detected inter-channel phase difference mixing parameter Φ of the left and right L, R audio channels can be determined as

$$Φ = ∠ ( \frac{L}{R} ) \qquad ( eq . 2 )$$

wherein Φ ranges from −π to π with Φ=0 indicating no inter-channel phase difference between the left and right L, R audio channels.

Furthermore, it is possible to determine a detected signal magnitude mixing parameter (expressed in decibels) for each fine granularity tile as

$${U}_{d B} = 10 {log}_{10} ( {\vert L \vert}^{2} + {\vert R \vert}^{2} ) . \qquad ( eq . 3 )$$

The spatial cue based separation module 10 may detect one or more of the tile specific mixing parameters from equations 1, 2 and 3 above and adjust the audio channels to approach e.g. a center panned audio signal with no inter-channel phase difference. However, as each tile commonly covers a very short time duration (e.g. 1 ms to 30 ms such as 20 ms) and narrow frequency range the tile specific mixing parameters may vary rapidly across time and/or frequency. To this end, the tile specific panning and inter-channel phase difference of multiple tiles are combined, and optionally weighted with the tile specific magnitude U_{dB}, to form a panning distribution and/or an inter-channel phase difference distribution over multiple tiles. These distributions may then be updated and used to adjust the channels at regular intervals (the intervals being much longer than that of a single tile or frame) so as to approach the predetermined mixing type.

For example, the tiles of multiple frames, such as 5 or 10 frames, are aggregated into an audio signal chunk, wherein the chunk includes between 200 and 300 ms of the audio signal's content and the chunk may be divided into comparatively coarse (e.g. octave or semi octave) chunk frequency bands. In some implementations, the average panning, referred to as Θ-middle, is determined across all tiles in a chunk frequency band and an associated panning distribution parameter, referred to as Θ-width, is determined across all tiles in a chunk frequency band indicating a symmetric deviation from Θ-middle which captures a predetermined ratio of the total signal energy (e.g. 40% of the energy). Similarly, the average inter-channel phase difference, referred to as Φ-middle, is determined across all tiles of a chunk frequency band and an associated inter-channel phase difference distribution parameter, referred to as Φ-width, is determined for each chunk frequency band indicating a symmetric deviation from Φ-middle which captures a predetermined ratio of the total signal energy (e.g. 40% of the energy).

The modification of the left and right audio channels L, R may then comprise adjusting the panning and/or inter-channel phase difference of each chunk frequency band such that Θ-middle and/or Φ-middle are moved to a predetermined position, e.g. Φ=0 and Θ=0 for a center panned predetermined mixing with no inter-channel phase difference. Additionally or alternatively, the modification of the left and right audio channels may entail “squeezing” the respective distribution such that Θ-width and/or Φ-width are reduced to a predetermined width or with a predetermined factor.

In one exemplary implementation, the spatial cue based separation module 10 operates in the STFT-domain with a sample rate of 48 kHz and frames comprising 4096 samples with a frame stride of 1024 samples (i.e. 75% overlap) and a Hann window or a square root of a Hann window. The mixing parameters are determined for each chunk frequency band wherein one chunk comprises 10 frames (1 current, 4 lookahead and 5 lookback) with a chunk stride of 5 frames. That is, a total buffer of about 277 ms content is considered when determining the mixing parameter in each chunk frequency band. With 75% overlap between tiles (frames) and a chunk stride of 5 frames the mixing parameter may be updated once every 5×1024 samples (or about once every 107 ms at 48 kHz sample rate) which determines the time resolution for the spatial cue based separation module 10. Additionally, it is envisaged that the at least one mixing parameter is interpolated between chunks. For example, the mixing parameter is interpolated once per frame meaning that the mixing parameter is updated once every 1024 samples (or about every 20 ms at 48 kHz sampling rate).

The frequency resolution of the spatial cue based separation module 10 is determined by the number and bandwidth of the chunk frequency bands which each chunk is divided into. In one exemplary embodiment, the spatial cue based separation module 10 operates at quasi-octave chunk frequency bands with band edges at 0 Hz, 400 Hz, 800 Hz, 1600 Hz, 3200 Hz, 6400 Hz, 13200 Hz and 24000 Hz resulting in seven frequency bands with different bandwidths, ranging from 400 Hz bandwidth for the frequency band covering 0 to 400 Hz to 10800 Hz bandwidth for the frequency band covering 13200 Hz to 24000 Hz.

The above time and/or frequency resolution of the spatial cue based separation module 10 are merely exemplary and other alternatives are envisaged. For example, it is envisaged that fewer or more frames are combined when forming a chunk and/or that the time stride/overlap of tiles (frames) and chunks can be varied. In general however, the spatial cue based separation module 10 benefits from operating at comparatively low time/frequency resolution compared to the subsequent source cue based separation module 20. For example, the spatial cue based separation module 10 determines the mixing parameter with a time and/or frequency resolution which is coarser than the time and/or frequency resolution of the source separation module, such as at least two times coarser, at least four times coarser, at least six times coarser, at least eight times coarser or at least ten times coarser.

For example, the processing of the spatial cue based separation module 10 may be as described in Master, Aaron S et al, “Dialog Enhancement via Spatio-Level Filtering and Classification”, AES Convention Paper 10427.

As a second example of the operation of the spatial cue based separation module 10, the panning and/or inter-channel phase difference mixing parameters determined from a plurality of detected fine granularity mixing parameters may be used as the target panning parameter Θ and/or the target phase difference parameter Φ as is described in “TARGET MID-SIDE SIGNALS FOR AUDIO APPLICATIONS” filed as U.S. Provisional Application No. 63/318,226 on Mar. 9, 2022, hereby incorporated by reference in its entirety. Here, the mixing parameters may be used to extract a target center-panned mid, M, and side, S, audio channel from the input left and right audio channels L, R as

$$M = cos ( Θ ) {e}^{i ( - Φ {sin}^{2} Θ )} L + sin ( Θ ) {e}^{i ( Φ {cos}^{2} Θ )} R \qquad ( eq . 4 )$$

$$S = sin ( Θ ) {e}^{i ( - Φ {sin}^{2} Θ )} L - cos ( Θ ) {e}^{i ( Φ {cos}^{2} Θ )} R \qquad ( eq . 5 )$$

wherein the target mid audio signal M will target any dominating audio source for inclusion in each frequency band. An intermediate center panned audio signal with a left and right audio channel Lᵢₙₜ, Rᵢₙₜ may then be extracted from the target mid M and target side S audio channel as

$${L}_{i n t} = M + S \qquad ( eq . 6 )$$

$${R}_{i n t} = M - S . \qquad ( eq . 7 )$$

wherein the dominating audio source of the input audio signal A has been shifted to a centered panning with reduced inter-channel phase difference. Accordingly, the extraction of the target mid audio signal M and reconstruction of a center panned left and right audio channel pair Lᵢₙₜ, Rᵢₙₜ is another exemplary way in which spatial source separation can be achieved based on one or more mixing parameters.

In some implementations, the target side audio signal S is ignored (e.g. set to zero) in equation 6 and 7 when determining the intermediate center panned audio signal channels Lᵢₙₜ, Rᵢₙₜ. As many target audio sources will be fully captured by the target mid audio signal M the target side audio signal S will mostly contain the unwanted audio signal components meaning that it can be ignored.

In the above, different examples of the operation of the spatial cue based separation module 10 have been presented. It is understood from these examples that the spatial cue based separation module 10 performs a detection operation and an extraction operation. The detection operation comprises determining the at least one detected mixing parameter with a fine granularity time-frequency resolution (e.g. determine the detected at least one mixing parameter for each tile) wherein extraction operation involves smoothing the detected at least one fine granularity mixing parameter is over time and/or frequency (e.g. aggregating the fine granularity mixing parameter over a chunk frequency bands) to obtain a comparatively coarser granularity mixing parameter. The time and/or frequency resolution of the spatial cue based separation module 10 is based on the coarser time and/or frequency resolution of the extraction operation. It is then the coarser at least one mixing parameter that is used to make the final adjustment of the mixing. That is, the detected fine granularity mixing parameters are not used directly to control the mixing as this could introduce noticeable acoustic artefacts due to rapid adjustment of the mixing (e.g. for each STFT-tile).

The spatial cue based separation module 10 outputs a resulting intermediate audio signal B which comprises audio content of a spatial mix which is easier for the source cue based separation module 20 to process (e.g. a center panned audio signal with little to no inter-channel phase difference).

The source cue based separation module 20 comprises a neural network trained to predict a noise reduced output audio signal C given samples of the intermediate audio signal B. The neural network has been trained to e.g. identify target audio content (e.g. speech or music) and amplify the target audio content and/or has been trained to identify undesired audio content (e.g. stationary or non-stationary noise) and attenuate the undesired audio content. To achieve this, the neural network may comprise a plurality of neural network layers and may e.g. be a recurrent neural network.

For example, the neural network in the source cue based separation module 20 is of a U-Net type architecture where the input to the neural network are frequency band energies, and the output are real-valued frequency band gains. This type of U-Net architecture is sometimes referred to as a U-NetFB. Given a stereo intermediate audio signal B the U-NetFB first downmixes the audio signal prior to predicting a gain mask based on the downmixed audio signal, whereby the resulting gain mask is applied to both audio channels of the intermediate audio signal B.

As another example, the neural network in the source cue based separation module 20 is an aggregated, multi-scale, convolutional neural network with a plurality of parallel convolutional paths, each convolutional path comprising one or more convolutional layers. With such a neural network, an aggregated output is formed by aggregating the outputs of the parallel convolutional paths whereby an output gain mask is generated based on the aggregated output. This type of neural network is for example described in more detail in “METHOD AND APPARATUS FOR SPEECH SOURCE SEPARATION BASED ON A CONVOLUTIONAL NEURAL NETWORK” filed as a PCT application and published as WO/2020/232180, hereby incorporated by reference in its entirety.

As is also shown in FIG. 1, time and/or frequency metadata D is provided to the source cue based separation module 20. The time and/or frequency metadata D indicates at least one of a time resolution and a frequency resolution at which the spatial cue based separation module 10 operates. For example, the time and frequency resolution of the spatial cue based separation module 10 is the chunk stride in the time domain and bandwidth of one chunk frequency band in the frequency domain. As another example, the time and frequency resolution of the spatial cue based separation module 10 is the frame stride in time domain and the bandwidth of one tile in the frequency domain. That is, the time and/or frequency metadata D indicates at least one of (i) the chunk stride in the time domain and/or the bandwidth of one chunk frequency band (e.g. a quasi-octave frequency band) in the frequency domain or (ii) the frame stride in the time domain and/or the bandwidth of one tile in the frequency domain. The time and/or frequency metadata D may be obtained from an external source (e.g. user specified or accessed from a database) or the time and/or frequency metadata D may be provided to the source cue based separation 20 by the spatial cue based separation module 10.

The source cue based separation module 20 processes the intermediate audio signal B based on the time and/or frequency metadata D. In some implementations, the spatial cue based separation module 10 operates with a time and/or frequency resolution which is much lower (i.e. coarser) compared to the resolution of the source cue based separation module 20. For instance, the spatial cue based separation module 10 operates with quasi-octave chunk frequency bands with a bandwidth of at least 400 Hz and the mixing parameter being updated about every 100 ms (chunk) or 20 ms (interpolated). However, the source cue based separation module 20 may operate on individual tiles, e.g. individual STFT-tiles, with a time resolution of a few milliseconds (e.g. 20 ms) and a frequency resolution of about 10 Hz.

By providing the time and/or frequency metadata D to the source cue based separation module 20 this module may then be configured to (i) use its default or typical time and/or frequency resolution, (ii) use the same time and/or frequency resolution of the spatial cue based separation module 10, or (iii) use a different time and/or frequency resolution which is different from either (i) or (ii). As an example of alternative (iii), the source cue based separation module 20 may be instructed to use a lower/coarser time and/or frequency resolution as opposed to a finer resolution, even if both the spatial cue based separation module 10 and the source cue based separation module 20 would typically operate with the finer time and/or frequency resolution.

With the time and/or frequency metadata D the source cue based separation module 20 can operate in a mode which is more suitable (in terms of separation performance and mitigating acoustic artifacts) for combination with the spatial cue based separation module 10, and which may differ from its typical operation without the spatial cue based separation module 10. The time and/or frequency metadata D may specify the more suitable time and/or frequency resolution granularity at which the source cue based separation module 20 shall operate.

In some implementations, the time and/or frequency metadata D indicates that the source cue based separation module 20 should operate and/or apply smoothing at a time and/or frequency resolution which is equal to or lower/coarser than the time and/or frequency resolution of the spatial source cue based separation module 10. For example, the source cue based separation module 20 operates with a frequency resolution identical to that used in the spatial cue based separation module 10 (e.g. equal to the chunk frequency bands) and the time resolution is between one and ten times coarser/lower than the time resolution of the spatial cue based separation module 10 (e.g. between one and ten times the time duration of a chunk).

As directly changing the resolution of the source cue base separation module 20 from its default value may lead to an increase residual noise that remains in the output audio signal C, the source cue based separation module 20 may in some implementations operate at its default time and/or frequency resolution (which may be finer than the time and/or frequency resolution of the spatial cue based separation module 10). In such implementations, the time and/or frequency metadata D indicates the smoothing in time and/or frequency that is to be applied the output audio signal C directly or to the predicted source gain mask G. For example, the smoothing may be configured to establish a frequency resolution identical to that used in the spatial cue based separation module 10 and a time resolution that is between one and ten times coarser/lower than the time resolution of the spatial cue based separation module 10.

In FIG. 2 it is shown that the intermediate audio signal B is optionally mixed with the input audio signal A in an intermediate mixing module 30a to generate a mixed intermediate audio signal B′. The mixed intermediate audio signal B′ is then provided to the source cue based separation module 20 which processes the mixed intermediate audio signal B′. The intermediate mixing module 30a generates the mixed intermediate audio signal B′ as a weighted linear combination of the input audio signal A and the intermediate audio signal B output by the spatial cue based separation module 10. For example, the mixing ratio of the intermediate mixing unit 30a mixes the intermediate audio signal B with the input audio signal A with a mixing ratio putting at least 15 dB emphasis on the intermediate audio signal B compared to the input audio signal A. In some implementations, no input audio signal A is mixed with the intermediate audio signal B, which may be achieved by omitting the intermediate mixing unit 30a entirely or setting a mixing ratio which mixes the intermediate audio signal B with the input audio signal A that puts ∞ dB emphasis on the intermediate audio signal B compared to the input audio signal A.

By reintroducing the input audio signal A into the intermediate audio signal B using mixing some of the unprocessed input audio signal A content is reintroduced into the intermediate audio signal B which may enhance the performance of the subsequent source cue base separation module 20 and/or provide a perceptually higher quality output audio signal C. In general, the remixing masks acoustic artifacts which may be introduced by a preceding separation module 10, 20. For instance, the neural network of the source cue based separation module 20 may be trained using training data that contains a mix of desired audio content (e.g. speech) and noise whereby the neural network has learned to suppress the noise and/or amplify the desired audio content. However, the spatial cue based separation module 10 may introduce acoustic artifacts that are not present in the training data which may lead to degraded performance of the source cue based separation module 20. By remixing the input audio signal A, these artifacts are masked which makes the mixed intermediate audio signal B′ more similar to the training data used to train the neural network of the source cue based separation module 20. Accordingly, by remixing the input audio signal A with the intermediate audio signal B these and other problems are avoided. On the other hand, the remixing still puts emphasis on the intermediate audio signal B over the input audio signal A such that the source cue based separation module 20 is still presented with a spatially separated (mixed) intermediate audio signal B.

Similarly, an output mixing module 30b is optionally provided for mixing the output audio signal C from the source cue based separation module 20 with at least one of the input audio signal A and the intermediate audio signal B to generate a mixed output audio signal C′. The mixed output audio signal C′ is generated as a weighted linear combination of the output audio signal C with at least one of the intermediate audio signal B and the input audio signal A. For example, the output mixing module 30b mixes the output audio signal C with a mixing ratio which emphasizes the output audio signal C with 20 dB compared to the intermediate audio signal B and/or the input audio signal A respectively.

Mixing the input audio signal A and/or the intermediate audio signal B into the output audio signal C may facilitate improving the perceptual quality of the final mixed output audio signal C′. In some cases, the processing by the separation modules 10, 20 may introduce acoustic artifacts. By remixing the input audio signal A and/or the intermediate audio signal B with the output audio signal C this issue is overcome as these artifacts are at least partially masked in the mixed output audio signal C′. Additionally, remixing the input audio signal A and/or the intermediate audio signal B with the output audio signal C means that even if any of the source separation modules 10, 20 where to suppress some part of the desired audio content, this content will still be present in the mixed output audio signal C′ in a limited amount.

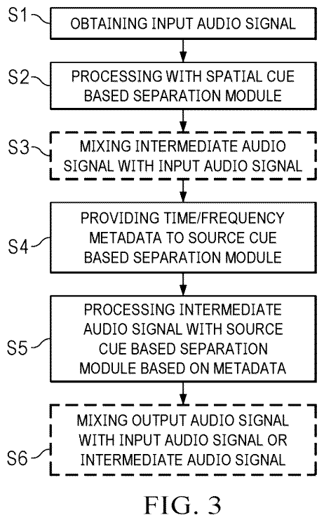

With further reference to the flow chart in FIG. 3 a method for processing audio for source separation will now be described in further detail. At step S1 an input audio signal A is obtained and provided to the spatial cue based separation module 10 which processes the input audio signal A at step S2 to obtain an intermediate audio signal B. The intermediate audio signal B is optionally provided to an intermediate mixing module 30a which mixes the intermediate audio signal B at step S3 with the input audio signal A to obtain a mixed intermediate audio signal B′. At step S4 time/frequency metadata D indicating a time and/or frequency resolution used by the spatial cue based separation module 10 is provided to the source cue based separation module 20 and at step S5 the time/frequency metadata D is used by the source separation module 20 to process the mixed intermediate audio signal B′ to form an output audio signal C. The output audio signal C is optionally provided to a mixing module 30b which mixes the output audio signal C at step S6 with at least one of the input audio signal A and the intermediate audio signal B to obtain a mixed output audio signal C′.

In the above, a method for processing audio for separation has been described. It is understood that the method can be carried out with or without any of the mixing steps performed by the mixing modules 30a, 30b. In other words, the mixing steps S3, S6 are entirely optional and independent of each other meaning that none of the mixing steps, one of the mixing steps or both of the mixing steps may be used with the remaining steps remaining unchanged. Similarly, utilization of the time/frequency metadata D during step S4 is optional and implementations with and without time/frequency metadata D based processing are envisaged.

It is further envisaged that processing the input audio signal A with the spatial cue based separation module 10 may further comprise transforming the input audio signal A to a domain in which the spatial cue based separation module 10 operates. For instance, the input audio signal A is originally in time domain, whereby the input audio signal A is transformed to STFT domain or QMF domain prior to ingestion into the spatial cue based separation module 10. Additionally or alternatively, the intermediate audio signal B is inverse transformed prior to being provided to the subsequent intermediate mixing unit 30a or source cue based separation module 20. Similarly, processing the intermediate audio signal B with the source cue base separation module may comprise transforming and inverse-transforming the intermediate audio signal B and output audio signal C.

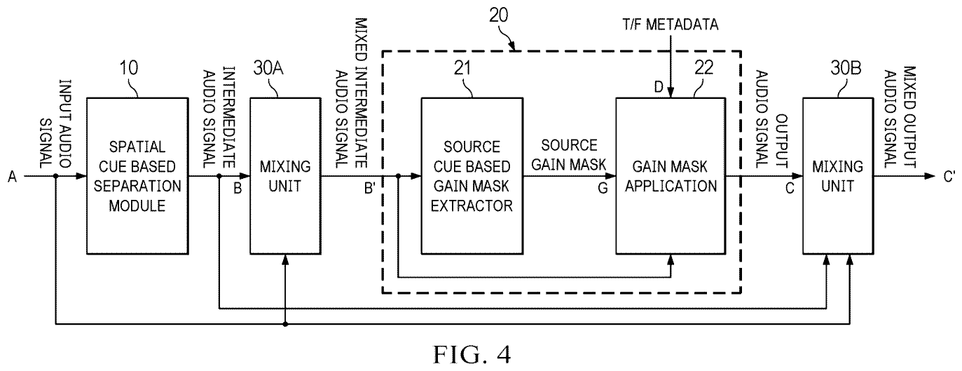

In some implementations, the source cue based separation module 20 comprises a source cue based gain mask extractor 21 and a gain mask applicator 22 as shown in FIG. 4. As described in the above, the source cue based separation module 20 comprises a neural network which is trained to generate an output audio signal C with reduced noise. This may be achieved with a neural network trained to predict a source gain mask G implemented as the source cue based gain mask extractor 21. The source cue based gain mask extractor 21 outputs the source gain mask G to a gain mask applicator 22 wherein the gain mask applicator 22 applies the source gain mask G to the (mixed) intermediate audio signal B, B′ to form noise reduced output audio signal C. Applying the source gain mask G may comprise multiplication of the source gain mask G with the corresponding time-frequency domain representation of the (mixed) intermediate audio signal B, B′.

A gain mask G is a predicted set of gains, with one gain for each tile of an audio signal. For instance, the neural network may be trained to predict a fine granularity gain mask with one gain for each STFT-bin of each frame. The predicted gains suppress the noise present in the audio signal while leaving the target audio content (e.g. speech and/or music). As an example, the (mixed) intermediate audio signal B, B′ is divided into a plurality of consecutive frames, wherein each frame is further divided into N tiles covering a respective frequency band, wherein N≥2. The neural network of the source cue based gain mask extractor 21 is then trained to predict N gains for each frame (one for each tile) to suppress the noise in the (mixed) intermediate audio signal B, B′. If the target audio content (e.g. speech and/or music) is concentrated in a first tile N=i this first tile i may be associated with a high gain whereas a different second tile that contains mostly noise is associated with a different lower gain which attenuates the second tile.

The gain mask applicator 22 may further be configured to consider the time and/or frequency metadata D when applying the source gain mask G. For instance, if the source cue based separation module 20 should operate at a time and/or frequency resolution other than a default or typical time and/or frequency resolution the gain mask applicator 22 may be configured smooth the source gain mask G prior to applying it to the (mixed) intermediate audio signal B, B′ and/or smooth the resulting audio signal after application of the source gain mask G. The smoothing will lower the time and/or frequency resolution (make it coarser) so as to e.g. achieve a resolution which matches (or is lower than) that of the spatial cue based separation module 10. That is, the source cue based gain mask extractor 21 may operate at a fine/high resolution compared to the spatial cue based separation module 10 however the gain mask applicator 22 smooths the source cue based gain mask G prior to application, rendering the total time and/or frequency resolution of the source cue based separation module 20 lower/coarser or equal to that of the spatial cue based separation module 10.

In one example embodiment, the spatial cue based separation module 10 operates with a chunk frequency bands of five to ten octave-width frequency bands, whereas the source cue based gain mask extractor 21 operates on individual tiles. The fine granularity gain mask G predicted by the source cue based gain mask extractor 21 may then be smoothed by the source gain mask applicator 22 to match the frequency resolution of the spatial cue based separation module 10. The smoothing may be applied using different techniques such as convolution with a smoothing window (in one dimension) or kernel (in two dimensions). As described in the above, the frequency resolution of the spatial cue based separation module 10 may be equal to the bandwidth of the chunk frequency bands which is a much lower resolution compared to the individual tile bandwidth.

In some implementations, the smoothing is done with convolutive smoothing windows moving only in the time dimension and spanning using frequency bands equal to the chunk frequency bands of the spatial cue based separation module 10. The time duration of the smoothing window is between one and ten times the length of the stride used in the spatial cue based separation module 10. The smoothing window may be a hamming window.

In some implementations, the spatial cue based separation module 10 may in a similar manner be realized as a spatial cue based gain mask extractor which determines or predicts a spatial gain mask wherein the spatial gain mask is provided to a spatial gain mask applicator which applies the spatial gain mask to the input audio signal A to form the intermediate audio signal B. That is, modifying the at least two channels of the input audio signal A may comprise determining and applying a spatial gain mask.

In some implementations, both the spatial cue based separation module 10 and the source cue based separation module 20 utilizes gain masks that are predicted by each module. The spatial cue based separation module 10 provides the intermediate audio signal B to the source separation module 20. In some such implementations, the gain mask predicted by each module 10, 20 is provided to a gain mask combiner and applicator which combines the two gain masks to form an aggregated gain mask and then applies the aggregated gain mask to the input audio signal A to form the output audio signal C. Optionally, the gain mask combiner and applicator also performs smoothing of the resulting combined gain mask.

The gain masks predicted by each module 10, 20 are not necessarily of the same time and/or frequency resolution and different techniques such as interpolation, data duplication or pooling may be used to make resolution of the different gain masks match. There are also many different methods for combining gain masks, for example, combining the gain masks of each module 10, 20 may comprise one of the following types of combination: multiplication, selecting the minimum value, selecting the maximum value, selecting the median value, selecting the mean value or any linear combination of the gain masks.

It is also envisaged that the two modules 10, 20 may operate in parallel wherein each module predicts a gain mask based on the input audio signal A and provides the respective gain masks to a gain mask combiner and applicator which combines the two gain masks to form an aggregated gain mask and then applies the aggregated gain mask to the input audio signal A to form the output audio signal C. In such implementations, there is no intermediate audio signal B. Optionally, the output audio signal Cis mixed with the input audio signal A to form a mixed output audio signal C′.

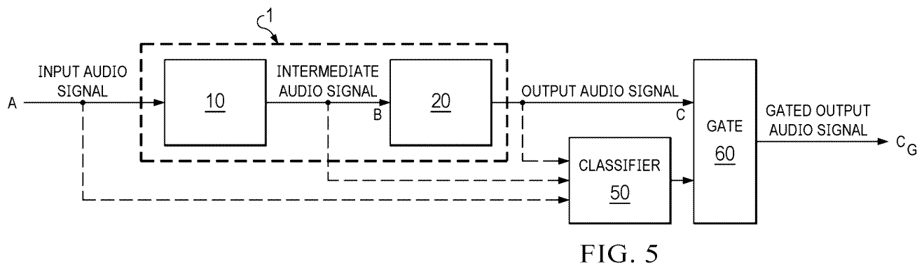

FIG. 5 depicts a block diagram of an audio processing system wherein the source separation audio processing system 1 is used together with a classifier 50 and a gating unit 60 to form a gated output audio signal CG. The classifier 50 operates on at least one of the input audio signal A, the (mixed) intermediate audio signal B, B′ and the (mixed) output audio signal C, C′ and determines a probability metric indicating a likelihood of the obtained audio signal comprising target audio content. The probability metric may be a value, wherein lower values indicate a lower likelihood and higher values indicates a higher likelihood. For example, the probability metric is a value between zero and one wherein values closer to zero indicate a low likelihood of the audio signal comprising the target audio content and values closer to one indicate a higher likelihood of the audio signal comprising the target audio content. The target audio content may e.g. be speech or music. In some implementations, the classifier 50 comprises a neural network trained to predict the probability metric indicating the likelihood that the audio signal comprises the target audio content given samples of the input, intermediate and/or output audio signal. For example, the neural network is a residual neural network (ResNet) trained to predict the probability metric given a time-frequency representation of the at least one of the input audio signal A, the (mixed) intermediate audio signal B, B′ and the (mixed) output audio signal C, C′. The time-frequency representation comprising a plurality of consecutive frames divided into a plurality of tiles. As another example, the classifier 50 comprises a feature extractor which extracts one or more features based on the time-frequency representation, whereby the at least one feature is provided to a Multi Layer Perceptron (MLP) neural network, or simplified ResNet neural network, trained to predict the probability metric. The feature extraction process may be specified manually, or it is envisaged that the feature extraction is performed by a trained feature extraction neural network.

As the (mixed) intermediate audio signal B, B′ and the (mixed) output audio signal C, C′ are processed versions of the input audio signal A in which the target audio content has been separated, any one of these audio signals can be provided as input to the classifier 50 to facilitate likelihood prediction accuracy and/or enable a simpler classifier 50 to be used. For instance, it may be easier for the classifier 50 to determine the probability metric accurately if the audio signal has already been separated using spatial cues, and optionally also source cues, compared to determining the probability metric for the input audio signal A which has not be subject to any separation processing by the separation modules 10, 20.

On the other hand, each separation module 10, 20 may introduce a delay brought by processing the audio signal with a predetermined amount of look-ahead and look-back samples. To this end, while providing the (mixed) output audio signal C, C′ to the classifier 50 may enable use of a simpler classifier 50 (e.g. a less complicated neural network with fewer layers and learnable parameters) and/or enhanced classification accuracy this also introduces a larger signal processing delay.

The probability metric is provided to the gating unit 60 which controls a gain of the (mixed) output audio signal C, C′ to form a gated output audio signal CG based on the likelihood. For example, if the probability metric determined by the classifier exceeds a predetermined threshold the gating unit 60 applies a high gain and otherwise the gating unit applies a low gain. In some implementations, the high gain is unity gain (0 dB) and the low gain is effectively a silencing of the audio signal (e.g. −25 dB, −100 dB, or −∞ dB). In this way, the output audio signal C, C′ becomes a gated output audio signal CG that isolates the target audio content. For example, the gated output audio signal CG comprises only speech and is effectively silenced for time instances when there is no speech.

In some implementations, the gating unit 60 is configured to smooth the gain applied by implementing a finite transition time from the low gain to the high gain and vice versa. With a finite transition time the switching of the gating unit 60 may become less noticeable and disruptive. For example, the transition from the low gain (e.g. −25 dB) to the high gain (e.g. 0 dB) takes about 180 ms and the transition from the high gain to the low gain takes about 800 ms, wherein the output audio signal C when there is no target audio content is further suppressed by a complete silencing (−100 dB or −∞ dB) of the output audio signal C after the high to low transition has elapsed. Alternatively, to enable faster onset the transition from the low gain to the high gain could be set to a shorter time than about 180 ms, such as about 1 ms.

In this way, the gated output audio signal CG will emphasize the target audio content (e.g. speech) by firstly separating the target audio content using spatial cues and source cues making the target audio content clearer and more intelligible when present in the audio signal and, secondly, by silencing the output audio signal C when the target audio content is not present in the input audio signal A.

Unless specifically stated otherwise, as apparent from the following discussions, it is appreciated that throughout the disclosure discussions utilizing terms such as “processing”, “computing”, “calculating”, “determining”, “analyzing” or the like, refer to the action and/or processes of a computer hardware or computing system, or similar electronic computing devices, that manipulate and/or transform data represented as physical, such as electronic, quantities into other data similarly represented as physical quantities.

It should be appreciated that in the above description of exemplary embodiments of the invention, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention. Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with instructions for carrying out such a method or element of a method forms a means for carrying out the method or element of a method. Note that when the method includes several elements, e.g., several steps, no ordering of such elements is implied, unless specifically stated. Furthermore, an element described herein of an apparatus embodiment is an example of a means for carrying out the function performed by the element for the purpose of carrying out the embodiments of the invention. In the description provided herein, numerous specific details are set forth. However, it is understood that embodiments of the invention may be practiced without these specific details. In other instances, well-known methods, structures and techniques have not been shown in detail in order not to obscure an understanding of this description.

The person skilled in the art realizes that the present invention by no means is limited to the embodiments described above. On the contrary, many modifications and variations are possible within the scope of the appended claims. For example, none, only one, or both, of the mixing modules 30a, 30b from FIG. 2 may be used regardless of whether each separation module operates using gain masks and/or regardless of the presence of a gain mask combiner and applicator.

1-36. (canceled)

37. A method of processing audio for source separation, the method comprising:
obtaining an input audio signal comprising at least two channels;
processing the input audio signal with a spatial cue based separation module to obtain an intermediate audio signal,
the spatial cue based separation module being configured to determine a mixing parameter of the at least two channels of the input audio signal and modify the at least two channels, based on the mixing parameter, to obtain the intermediate audio signal; and
processing the intermediate audio signal with a source cue based separation module to generate an output audio signal,
the source cue based separation module being configured to implement a neural network trained to predict a noise reduced output audio signal given samples of the intermediate audio signal.

38. The method according to claim 37, wherein the input audio signal is divided into a plurality of consecutive frames, and wherein the mixing parameter indicates at least one of:
a distribution of the panning of the at least two channels over a plurality of frames in at least one frequency band, and
a distribution of the inter-channel phase difference of the at least two channels in at least one frequency band over a plurality of frames.

39. The method according to claim 38, wherein the mixing parameter is determined for a plurality of frequency bands.

40. The method according to claim 37, wherein the spatial cue based separation module operates at a first time and/or frequency resolution, the method further comprising:
providing, by the spatial cue based separation module, metadata to the source cue based separation module, the metadata indicating the time and/or frequency resolution of the spatial cue based separation module; and
generating, by the source cue based separation module, the output audio signal based on the intermediate audio signal and the metadata.

41. The method according to claim 40, wherein the intermediate audio signal is divided into a plurality of consecutive frames and each frame is divided into a plurality of frequency bands, and wherein generating the output audio signal comprises:
predicting, by the neural network, a source gain mask, the source gain mask indicating a gain for applying to each frequency band of each frame of the intermediate audio signal; and
smoothing the source gain mask based on the metadata.

42. The method according to claim 41, wherein smoothing the source gain mask comprises:
smoothing over time in frequency bands equal to the frequency bands indicated by the frequency resolution of the spatial cue based separation module.

43. The method according to claim 42, wherein the spatial cue based separation module determines the mixing parameter by averaging a detected mixing parameter over a set of frames, and
wherein the smoothing over time is performed with a smoothing window with a receptive field in the time dimension being equal to or greater than the total time duration of the set of frames.

44. The method according to claim 42, wherein the smoothing over time is performed with a Hamming window.

45. The method according to claim 37, wherein the spatial cue based separation module determines the mixing parameter with a time resolution which is lower than the time resolution of the source cue based separation module, preferably at least two times lower, more preferably at least four times lower, most preferably at least six times lower.

46. The method according to claim 37, wherein the spatial cue based separation module determines the mixing parameter with a frequency resolution which is lower than the frequency resolution of the source cue based separation module, preferably at least two times lower, more preferably at least five times lower, most preferably at least ten times lower.

47. The method according to claim 37, further comprising:
mixing the intermediate audio signal with the input audio signal to generate a mixed intermediate audio signal; and
providing the mixed intermediate audio signal to the source cue based separation module.

48. The method according to claim 37, further comprising:
mixing the output audio signal with the input audio signal to generate a mixed output audio signal.

49. The method according to claim 37, further comprising:
mixing the output audio signal with the intermediate audio signal to generate a mixed output audio signal.

50. The method according to claim 37, wherein the input audio signal is divided into a plurality of consecutive frames and each frame is divided into a plurality of frequency bands,
wherein spatial cue based separation module is further configured to determine a spatial gain mask based on the mixing parameter, the spatial gain mask indicating a gain for applying to each frequency band of each frame of the input audio signal and modifying the at least two channels by applying said spatial gain mask.

51. The method according to claim 50, wherein the intermediate audio signal is divided into a plurality of consecutive frames and each frame is divided into a plurality of frequency bands, and wherein generating the output audio signal comprises:
predicting, by the neural network, a source gain mask, the source gain mask indicating a gain for applying to each frequency band of each frame of the intermediate audio signal;
combining the source gain mask and the spatial gain mask to form an aggregate gain mask; and
applying the aggregate gain mask to the input audio signal.

52. The method according to claim 37, further comprising:
providing at least one of the input audio signal, the intermediate audio signal and the output audio signal to a classifier;
determining, with the classifier, a probability metric indicating a likelihood that at least one of the input audio signal, the intermediate audio signal and the output audio signal comprises a target audio source; and
controlling a gain of the output audio signal based on the probability metric.

53. The method according to claim 37, wherein the source cue based separation module is configured remove at least one of stationary noise, non-stationary-noise, background audio content and reverberation.

54. An audio processing system for source separation, comprising
a spatial cue based separation module, configured to obtain an input audio signal comprising at least two channels and process the input audio signal to obtain an intermediate audio signal, the spatial cue based separation module being configured to determine a mixing parameter of the at least two channels of the input audio signal and modify the at least two channels, based on the mixing parameter, to obtain the intermediate audio signal, and
a source cue based separation module configured to process the intermediate audio signal to generate an output audio signal by implementing a neural network trained to predict a noise reduced output audio signal given samples of the intermediate audio signal.

55. The audio processing system according to claim 54, wherein the input audio signal is divided into a plurality of consecutive frames, and wherein the mixing parameter indicates at least one of:
a distribution of the panning of the at least two channels over a plurality of frames in at least one frequency band, and
a distribution of the inter-channel phase difference of the at least two channels in at least one frequency band over a plurality of frames.

56. The audio processing system according to claim 55, the mixing parameter is determined for a plurality of frequency bands.
